(19) United States
(12) Patent Application Publication
(10) Pub. No.: US 2022/0112901 A1
(43) Pub. Date: Apr. 14, 2022

(54) IMPELLER OF A MOTOR VEHICLE

(71) Applicant: Brose Fahrzeugteile SE & Co. Kommanditgesellschaft, Würzburg, Würzburg (DE)

(72) Inventor: Michael MAUSS, Oldenburg (DE)

(73) Assignee: Brose Fahrzeugteile SE & Co. Kommanditgesellschaft, Würzburg, Würzburg (DE)

(21) Appl. No.: 17/425,139

(22) PCT Filed: Jan. 22, 2020
(86) PCT No.: PCT/EP2020/051490

§ 371 Date: Jul. 22, 2021

(30) Foreign Application Priority Data
Jan. 23, 2019 (DE) 20 2019 100 367.7

(51) Int. Cl. F04D 29/32; F01P 5/02; F04D 25/06; F04D 19/00; F04D 29/34

(52) U.S. Cl. CPC F04D 29/325; F01P 5/02; F04D 29/34; F04D 19/002; F04D 25/06

(57) ABSTRACT

An impeller of a motor vehicle, in particular a cooling fan, comprising a hub, to which a number of fan blades are connected. The fan blades are inclined in relation to a rotational axis of the impeller and have in each case a section which in the top view is S-shaped along the rotational axis.

### CROSS-REFERENCE TO RELATED APPLICATIONS

This application is the U.S. National Phase of PCT Application No. PCT/EP2020/051490 filed on Jan. 22, 2020, which claims priority to German Patent Application No. DE 20 2019 100 367.7, filed on Jan. 23, 2019, the disclosures of which are hereby incorporated in their entirety by reference herein.

### TECHNICAL FIELD

The present disclosure relates to an impeller of a motor vehicle, including an impeller for use in radiator fan of the motor vehicle.

### BACKGROUND

Motor vehicles with an internal combustion engine exhibit considerable evolution of heat during operation. To maintain the operating temperature of the internal combustion engine and also for the operation of an air conditioning system, a liquid coolant is usually used, which in turn must be cooled. This is usually effected by means of a radiator core, which is acted upon by a relative wind and which is in heat exchange with the coolant. For example, the coolant is passed into tubes which are incorporated into the radiator core. Since, particularly at low vehicle speeds, the relative wind is normally not sufficient for cooling, there is a known practice of using an electric fan, by means of which the relative wind is increased.

### SUMMARY

In this case, the fan is arranged behind the radiator core in the direction of travel. With the aid of an impeller of the fan, the air is sucked through the radiator core and directed onto the internal combustion engine. There, the air absorbs excess heat of the internal combustion engine and carries it away. In this case, the air strikes the internal combustion engine substantially at an obtuse angle and is deflected by the latter, for example by 90°. As a result, turbulence occurs, leading to an increase in drag and thus to a reduction in the air volume throughput. Noise also develops, and this may be troublesome.

The underlying object of the present disclosure is to specify a particularly suitable impeller of a motor vehicle and a particularly suitable radiator fan of a motor vehicle, an air volume throughput in particular being increased.

The impeller is a component of a motor vehicle such as a component of a radiator fan. In this case, the impeller is suitable, in particular provided and set up, to suck or blow air through a radiator of the motor vehicle. The radiator fan and thus also the impeller may be used for cooling an internal combustion engine of the motor vehicle. Suitably, a cooling liquid is cooled by means of the radiator and/or an air flow is directed onto the internal combustion engine, where present, by means of the impeller. Alternatively, the impeller is, for example, a component of a blower, by means of which, air is conveyed into an interior of a motor vehicle. The motor vehicle is suitably land-based and is, for example, a passenger car. As an alternative to this, the motor vehicle is a commercial vehicle, e.g. a truck or a bus.

As an example, the impeller has a substantially planar configuration. At least, however, the extent of the impeller in one plane is greater than perpendicular thereto. The impeller is suitable, in particular provided and set up, to be rotated about an axis of rotation. As an example, the axis of rotation is perpendicular to the plane within which the impeller is arranged. The impeller may be an axial impeller. Thus, during operation, air is moved along the axis of rotation by means of the impeller.

The diameter of the impeller is expediently between 20 cm and 50 cm, between 25 cm and 45 cm and, for example, substantially equal to 30 cm, with a deviation of 5 cm, 2 cm or 0 centimeters in each case expediently being present.

The impeller itself has a hub, to which a number of fan blades is attached. The impeller may be suitable, provided and set up, to be secured on an electric motor. In the assembled state, the electric motor, where present, by means of which the impeller is rotated about the axis of rotation, is expediently secured on the hub. In this case, the hub is suitably arranged concentrically with respect to the axis of rotation, which reduces unbalance and thus unwanted noise generation and excessive loading. The hub may have a substantially pot-shaped configuration, a pot base expediently being arranged substantially perpendicularly to the axis of rotation. The fan blades are suitably attached to an outer circumference of a wall of the pot-shaped hub. If the hub is of pot-shaped configuration, the pot opening may be arranged counter to any air flow, including air flow from a relative wind direction and/or a direction of movement of the motor vehicle. Thus, air resistance is reduced. In this case, the hub is expediently designed to be substantially smooth on the outside.

The fan blades are attached to the hub and are, for example, in one piece therewith. The complete impeller is expediently in one piece, simplifying production. As an example, the impeller is made from a plastic, thus reducing weight and simplifying shaping. In this case, the impeller may be produced in a plastic injection molding process. The fan blades, also referred to as impeller blades, may be structurally identical to one another, simplifying production and assembly. The fan blades are inclined with respect to the axis of rotation. Thus, each of the fan blades has a respective main direction of extent which is inclined with respect to the axis of rotation. As an example, an angle of between 10° and 80° or between 20° and 70° is formed in this case. Owing to the inclination, air is moved in the axial direction, that is to say along the axis of rotation or at least parallel to it, by means of the impeller during operation. Each of the fan blades furthermore has a substantially radial course, for example with respect to the axis of rotation, with the result that the fan blades point outward from the hub.

Each of the fan blades has a respective section which is of s-shaped configuration in a plan view along the axis of rotation. Thus, in the respective section, each of the fan blades is curved differently in the tangential direction with respect to the axis of rotation. Consequently, each of the fan blades has not only a course in the radial direction but also in the tangential direction, with the tangential direction changing in the process, so that there is not only a single curvature. For example, each of the fan blades also has a further section which, for example, is of straight configuration and extends substantially radially. Alternatively, in a plan view along the axis of rotation for example, the further section is of C-shaped configuration. As an example, each of the fan blades may include a plurality of further sections. In an alternative to this, each fan blade is formed in each case by means of the s-shaped section.

In one or more embodiments, the course of each fan blade in the region of the hub is substantially radial, such as, strictly radial, or there is a deviation of 5°, 2° or 1°. Owing to the s-shaped section, including the radially outer end of each fan blade is offset with respect to its radially inner end in the respective tangential direction. The respective radial outer end has a radial and tangential course, for example. In one or more embodiments, however, the radially outer end expediently extends only in the radial direction, there being, for example, a deviation of 10°, 5°, 2° or 0° with respect to the strictly radial direction. For example, the complete s-shaped section is offset in the preferential direction of rotation with respect to further components of the respective fan blade. In this case, only the radially outer end is offset counter to the preferential direction of rotation, at least with respect to further components of the s-shaped section.

Owing to the s-shaped section, each fan blade acts both in the manner of a nozzle and of a diffuser. Thus, a motion component directed radially outward with respect to the axis of rotation is introduced into the air flow which passes through the impeller in operation, and therefore the air flow passes through a larger area behind the impeller in the direction of the air flow, which is for example parallel to the axis of rotation, than is covered by the impeller. Owing to the increased area, a velocity of the air flow is reduced and consequently a pressure is increased. Therefore, an increased air volume is delivered by the impeller, while a rotational speed of the impeller is not increased. Consequently, this can essentially be operated with a constant power. In summary, a volume flow, that is to say the air volume throughput, is increased, improving a cooling performance. Alternatively, it is possible to operate the impeller at a lower rotational speed with the same air volume throughput, which reduces noise generation.

In addition, owing to the introduction of the radial motion component into the air flow, the air flow is fanned out by means of the impeller, with the result that the air flow does not impinge at an obtuse angle on an object arranged behind it, such as an internal combustion engine. This results in less eddying and turbulence in the air stream, which in turn increases efficiency and reduces noise generation. Furthermore, separation of the air flow from the component of the impeller is avoided and thus further turbulence is avoided, which likewise leads to an increase in efficiency and the avoidance of excessive noise generation.

In one or more embodiments, it is possible to operate the impeller in the two different directions of rotation with respect to the axis of rotation on account of the s-shaped section. As an example, however, the impeller has just one preferential direction of rotation. In this case, the impeller can be operated only in the preferential direction of rotation. For example, the fan blades have an aerodynamic profile perpendicularly to their course and/or to the respective radial direction, which profile expediently has a thickened portion. By virtue of the aerodynamic profile, air flow delivery is improved. As an example, the cross section of each fan blade is constant, in particular perpendicularly to the respective radial direction. The cross section therefore does not change on account of the s-shaped design, simplifying production.

In one or more embodiments, the radial ends of the fan blades are offset counter to the preferential direction on account of the s-shaped configuration of the section. In other words, the fan blades are arranged in such a way that the end offset furthest in the tangential direction in the preferential direction of rotation is located in front of the radial end of the fan blade, in particular in front of both radial ends of the fan blade. At least, however, the radially outer end of each fan blade does not form the tangential end of the fan blade in the preferential direction of rotation. By virtue of such an arrangement, separation of an air flow in the region of the radial ends of the fan blades is avoided, thus ensuring that comparatively little turbulence is introduced into the air flow which passes through the impeller and is delivered by means of the latter. Thus, efficiency is further increased and noise generation is further reduced.

For example, a trailing edge of each fan blade with respect to the preferential direction of rotation is rectilinear in a plan view in the preferential direction of rotation. In other words, the edge expediently has only a radial and possibly tangential course. In the axial direction, however, that is to say parallel to the axis of rotation, the edge has no extent. In one or more embodiments, however, the trailing edge of the fan blades with respect to the preferential direction of rotation is undulating in a plan view in the preferential direction of rotation. Thus, the edge has an extent in the axial direction, that is to say parallel to the axis of rotation, which alternates, such as, in the tangential direction. Expediently, a wave shape, that is to say expediently a sinusoidal shape or substantially sinusoidal shape, is formed by means of the edge. For example, the cross section parallel to the axis of rotation is of undulating configuration in the region of the rear end of each fan blade. Owing to the wave shape, there is an improved volume throughput of the air, for which reason efficiency is further increased. In this case, a suitable flow profile is introduced into the air flow passing through the impeller by means of the undulating configuration of the trailing edge. As a result, an additional motion component oriented radially outward is introduced into the air flow, further increasing an air volume throughput.

For example, the leading edge of the fan blades with respect to the preferential direction of rotation is of undulating configuration in a plan view counter to the preferential direction of rotation. As another example, however, this edge is straight. Thus, guidance of the air along the fan blades is improved. In this case, the front edge may be rounded, which reduces drag. As yet another example, the leading edge of the fan blades is straight and the trailing edge of the fan blades is undulating, in each case with respect to the preferential direction of rotation, with, for example, a continuous transition or at least partially continuous transition taking place between the edges. In other words, each of the fan blades is stepless. Thus, drag is further reduced.

For example, the s-shaped section is arranged substantially in the center of the respective fan blade in the radial direction. As an alternative to this, the radially inner end of each fan blade, may be formed by means of the s-shaped section. In one or more embodiments, however, each of the s-shaped sections is offset outward in each case in the radial direction with respect to the axis of rotation. In other words, each of the s-shaped sections may be located in the outer half of each of the fan blades. For example, the outer half of each fan blade is formed by means of the s-shaped section. The radially inner part of each fan blade is, for example, rectilinear or of C-shaped configuration in a plan view. In the radially outer region of the impeller, the fan blades have an increased velocity, with the result that an effect of the s-shaped section is increased in this region. In addition, an air volume moved by means of the fan blades is increased in this region. In other words, in this case, the essentially largest possible volume flow of air is moved by means of the s-shaped section.

For example, the orientation of the fan blades alternates in the tangential direction, with the result that the s-shaped sections each face one another. However, the s-shaped sections face in the same direction. Alternatively, or in combination, thereto/therewith the s-shaped sections are, for example, at different distances from the hub in the radial direction. As an example, the distances between adjacent fan blades in the tangential direction alternate. The fan blades are expediently arranged in a rotationally symmetrical manner with respect to the hub. The angle of symmetry may be 360° divided by the number of fan blades. As an example, the complete impeller is of rotationally symmetrical configuration, the angle of rotation being, such as, 360° divided by the number of fan blades. As a result of the rotationally symmetrical configuration, unbalance is prevented or at least reduced, and therefore noise generation during operation is reduced. Loading of the mechanical component of the impeller and of components connected thereto, in particular of any electric motor, is also reduced.

For example, the fan blades are of tapered configuration, the taper being in the radial direction, for example. Thus, the respective radially outer end of each fan blade has a smaller extent in the tangential direction and/or perpendicularly to the respective radial direction than the radially inner end. As an alternative to this, the radially inner end or a region of the fan blade lying therebetween is tapered. As an example, however, the extent of each fan blade in the tangential direction does not change, or the change is less than 10% of the extent of the respective fan blade in the tangential direction. As another example, the change is less than 5% of the extent of the respective fan blade in the tangential direction. Thus, production is simplified and weight is reduced, yet a comparatively robust impeller is provided. Adaptation and, in particular, simulation are also simplified. In addition, a comparatively large volume of air is delivered in this way by means of each of the fan blades.

For example, each of the fan blades has a blunt end in the radial direction. As an alternative to this, the radially outer ends of the fan blades are bent over, in particular in the manner of a winglet. In one or more embodiments, however, the impeller has an outer ring which is arranged concentrically with the hub and to which the radially outer ends of the impeller vanes are attached. Thus, the fan blades are stabilized by means of the outer ring. The outer ring is, for example, of substantially hollow cylindrical configuration. In the axial direction, for example, that is to say parallel to the axis of rotation, the outer ring has an extent of between 1 cm and 10 cm, for example of between 2 cm and 5 cm, and suitably equal to 3 cm.

In one or more embodiments, leakage air between the impeller and any fan frame surrounding the circumference of the impeller is limited or prevented by means of the outer ring. For this purpose, a seal, for example a brush seal, is expediently attached to an outer side of the outer ring. Alternatively, or in combination with this, the outer ring is produced at least in some section or sections in the manner of a labyrinth seal and consequently expediently has a contour which, in the assembled state, engages in a corresponding contour, in particular of any fan frame present, but is spaced apart from the latter. Thus, on the one hand, friction is not increased while, on the other hand, air is prevented from passing between the impeller and the frame, in particular counter to the direction of travel. Thus, efficiency is further increased.

The radiator fan is a component of a motor vehicle and is expediently used for cooling an internal combustion engine. In other words, the radiator fan is a main fan. As an alternative to this, the radiator fan is, for example, a component of an air-conditioning system or of an auxiliary unit of the motor vehicle. The radiator fan expediently comprises a radiator, which in particular has a radiator core, through which a number of tubes is passed. In this case, for example, the radiator core is in thermal contact with the tubes. During operation, a cooling liquid may be conveyed within the tubes. The radiator core is, for example, of substantially cuboidal configuration. In addition, the radiator fan comprises a fan frame, which has a round aperture. An impeller with a hub, to which is attached a number of fan blades that are inclined with respect to an axis of rotation of the impeller, is arranged within the round aperture, expediently parallel to the latter and/or to the fan frame. The fan blades each have a section which is of s-shaped configuration in a plan view along the axis of rotation. The impeller may be arranged concentrically with the aperture.

In addition, the radiator fan comprises an electric motor, which is, for example, a brushed commutator motor or a brushless DC motor (BLDC). The electric motor is secured on the fan frame. For example, the fan frame comprises a motor mount, which is held above the aperture by means of a number of struts. In this case, an axis of rotation of the electric motor is arranged perpendicularly to the aperture and, may extend on the axis of rotation of the impeller, such as on a straight line which extends through the center of the aperture. For example, the electric motor is adhesively bonded or screwed to the motor mount. Thus, the electric motor is held in a comparatively secure manner on the motor mount.

The impeller is driven by means of the electric motor and may be attached to the latter, for example to a shaft of the electric motor. For example, the hub is mechanically directly coupled to the electric motor. In this case, for example, the impeller additionally may include the outer ring, to which the fan blades are attached at their radial end. The fan blades are stabilized by means of the outer ring, which improves an acoustic effect. As an example, the outer ring engages in a corresponding receptacle or contour of the fan frame, and they may be spaced apart from one another. In one or more embodiments, a labyrinth seal is formed between them. Thus, propagation of leakage air is prevented. Alternatively, or in combination with this, a brush seal or the like is arranged between the outer ring, where present, and the fan frame.

The fan frame may be attached to the radiator, expediently fastened. For example, the fan frame is screwed to the radiator or adhesively bonded thereto. In particular, the fan frame covers any radiator core. In other words, the fan frame is congruent with the radiator core or, for example, with the entire radiator. Thus, air is prevented from passing between the radiator and the fan frame, and the air is consequently guided in a comparatively efficient manner by means of the fan frame. The fan frame may be arranged downstream of the radiator, that is to say expediently behind the radiator in the direction of travel of the motor vehicle.

The advantages and further developments mentioned in connection with the impeller can also be applied analogously to the radiator fan and vice versa.

### BRIEF DESCRIPTION OF THE DRAWINGS

Exemplary embodiments of the invention are explained in greater detail below with reference to the drawings. In the drawings:

FIG. 1 shows schematically a land-based motor vehicle with a radiator fan,

FIG. 2 shows a partial view of the radiator fan with an impeller in a schematically simplified form in an exploded view,

FIG. 3 shows the impeller in a plan view,

FIG. 4 shows a segment of the impeller in a plan view,

FIG. 5 corresponding to FIG. 4, shows an alternative embodiment of the impeller, and

FIG. 6 shows the impeller as per FIG. 5 in a plan view of a fan blade counter to a direction of rotation.

In all the figures, mutually corresponding parts are provided with the same reference signs.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 schematically shows, in simplified form, a motor vehicle 2 with an internal combustion engine 4. The motor vehicle 2 is driven by means of the internal combustion engine 4. For this purpose, the internal combustion engine 4 is operatively connected to at least one of the four wheels 6 of the motor vehicle 2 by means of a drive train (not shown specifically). In addition, the motor vehicle 2 comprises a radiator fan 8, which is used to cool the internal combustion engine 4. Thus, the radiator fan 8 is a main fan of the motor vehicle 2. The radiator fan 8 is fluidically connected to the internal combustion engine 4 by means of a number of lines 10, through which, during operation, a cooling liquid is passed from the radiator fan 8 to the internal combustion engine 4 and through cooling ducts there. Excess heat is absorbed by means of the cooling liquid and returned to the radiator fan 8, by means of which the cooling liquid is cooled.

The radiator fan 8 has a radiator 12 with a radiator core (not shown specifically) through which a number of tubes is guided and thermally contacted therewith. The tubes are fluidically coupled to the lines 10, and therefore the cooling liquid is passed through the tubes during operation. The radiator fan 8 further comprises a fan frame 14, which is arranged behind the radiator 12 in a direction of travel 16 of the motor vehicle 2. An electric motor 18 is secured on the fan frame 14. During operation, a relative wind passes through the radiator 12 and is suitably shaped by means of the fan frame 14. When the motor vehicle 2 is at a standstill, air is sucked through the radiator 12 by means of the electric motor 18, ensuring that, during operation, the air flow passes through the radiator 12 essentially at all times or at least in accordance with existing requirements. Cooling of the radiator 12 thus takes place, for which reason there is no overheating of the radiator fan 8, even after comparatively prolonged operation of the internal combustion engine 4. In addition, the air passing through the radiator fan 8 is guided to the internal combustion engine 4 by means of the fan frame 14 and, in this way, the engine is additionally cooled from the outside.

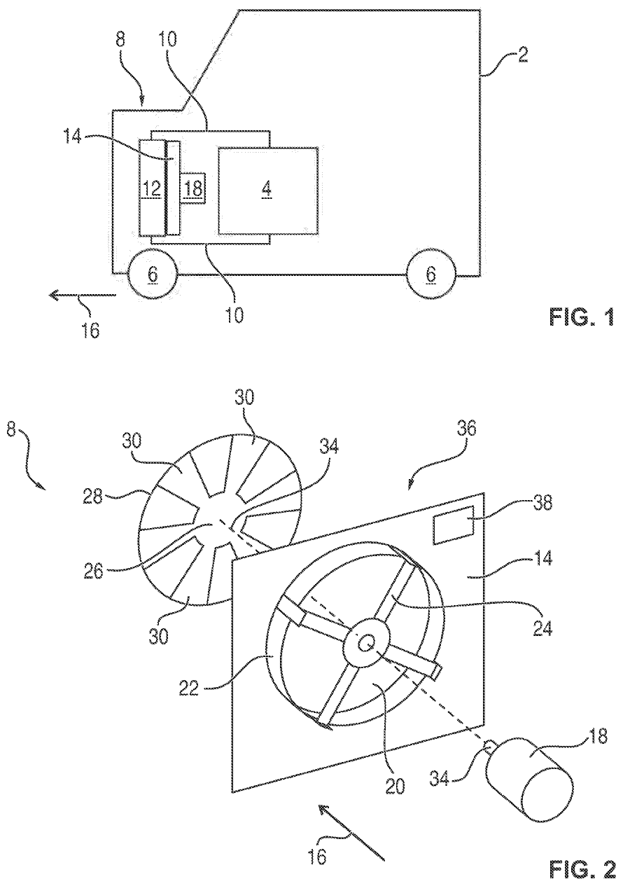

FIG. 2 shows the radiator fan 8 in a schematically simplified form in perspective in an exploded view, the radiator 12 being omitted. Secured on the radiator 12 is the fan frame 14, which completely covers the radiator core (not shown specifically) and is congruent therewith. The fan frame 14 is of substantially planar design and has a round aperture 20, which is oriented perpendicularly to the direction of travel 16. The aperture 20 has a diameter of 30 cm and is surrounded at the circumference by a rim 22, which is of hollow-cylindrical configuration and is arranged concentrically with the aperture 20. The diameter of the rim 22 is equal to the diameter of the aperture 20, and the rim 24 has a length of 2 cm in the axial direction with respect to the aperture 22, that is to say parallel to the direction of travel 16. In the assembled state, the rim 22 is located on that side of the fan frame 14 which faces away from the radiator 12.

The fan frame 14 further comprises a motor mount 24, which is arranged above the aperture 20, counter to the direction of travel 16. In the assembled state, the electric motor 18 is held by means of the motor mount 24, and the electric motor 18 is thus secured on said mount. In this case, the electric motor 18 is located on the opposite side of the fan frame 14 from the radiator 12. A shaft 34 of the electric motor 18 projects through the motor mount 32 in the direction of travel 16 and is secured on a hub 26 of an impeller 28 for conjoint rotation therewith. Thus, the impeller 38 is driven by means of the electric motor 18, which is held by means of the motor mount 24. A number of fan blades 30 is attached to the hub 26, which fan blades are surrounded at the circumference by means of an outer ring 32 and are attached to the latter. The hub 26, the fan blades 30, and the outer ring 32 are produced in one piece in a plastic injection molding process.

In the assembled state, the impeller 28 is arranged within the aperture 22, parallel thereto, wherein the outer ring 32 is surrounded radially at the circumference by means of the rim 24. During operation, the impeller 38 is rotated by means of the electric motor 18 about an axis of rotation 34 which is parallel to the direction of travel 16 and which extends through the center of the aperture 20. Thus, during operation, air is sucked through the aperture 22 counter to the direction of travel 16. Between the outer ring 32 and the rim 24, a flow of air is prevented by virtue of a seal (not shown specifically), e.g. a labyrinth seal.

In addition, the fan frame 14 includes a dynamic pressure flap 36 that comprises an opening covered by a flap 38. If there is a comparatively high (air) pressure in front of the fan frame 14 in the direction of travel 16, for example in the case of a comparatively fast movement of the motor vehicle 2, passage of the air through the aperture 20 is partially impeded by the impeller 28 or the impeller 28 would have to be rotated comparatively quickly. However, this would lead to an increased load on the electric motor 18 and the further component and to increased noise generation. From a certain pressure, the flap 38 is therefore pivoted and the opening is exposed, thus allowing air to flow through it. Thus, an air throughput through the radiator 12, which is located in front of the fan frame 14 in the direction of travel 16, is increased. At a comparatively low air pressure in front of the fan frame 14, as is the case when the motor vehicle 2 is at a standstill, the flap 38 is closed, and therefore formation of a circular air flow passing only through the opening of the dynamic pressure flap 36 and the aperture 22 is prevented. Thus, there is also always a sufficient air flow through the radiator 12.

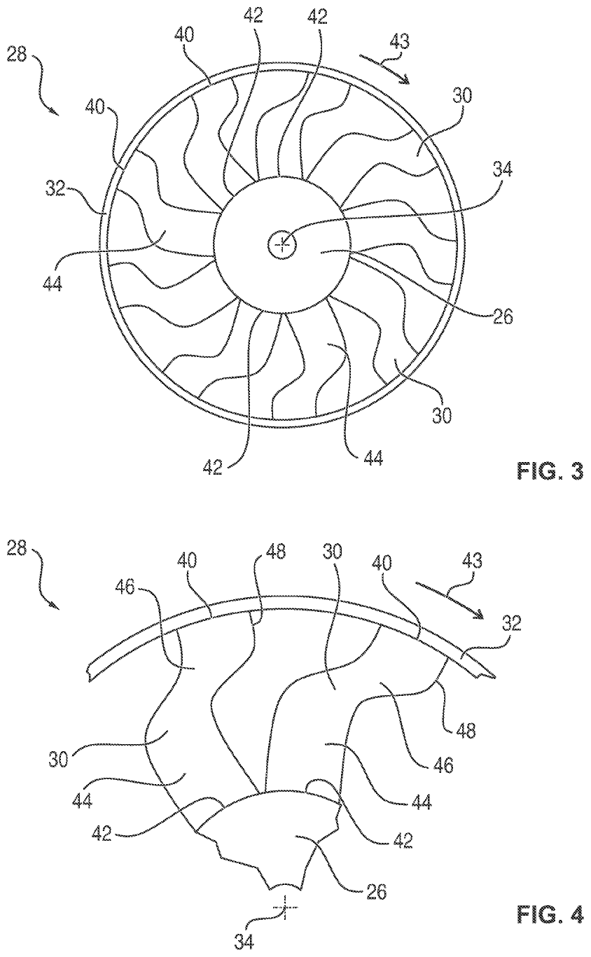

In FIG. 3, the impeller 28 is shown in a plan view along the axis of rotation 34, counter to the direction of travel 16. In FIG. 4, an enlarged segment of the impeller 28 is shown, corresponding to the illustration in FIG. 3. The hub 26 is of pot-shaped configuration, and the base of the hub 26 faces in the direction of travel 16. The fan blades 30 are attached to an outer wall of the hub 26. In the variant illustrated here, the impeller 28 has a total of nine such fan blades 30. The fan blades 30 are arranged in a rotationally symmetrical manner with respect to the hub 26, the axis of symmetry coinciding with the axis of rotation 34. In this case, the complete impeller 28 is rotationally symmetrical, the angle of symmetry corresponding to 40°.

The fan blades 30 are arranged between the outer ring 32 and the hub 26, in the radial direction with respect to the axis of rotation 34, the radially outer end 40 of the blades being connected to the outer ring 32. The outer ring 32 is arranged concentrically with respect to the hub 26 and consequently also with respect to the axis of rotation 34. The radially inner end 42 of each fan blade 30 is attached to the hub 26 and formed integrally thereon. In this arrangement, each fan blade 30 has a substantially radial course in the region of the two radial ends 40, 42.

Each fan blade 30 is inclined with respect to the axis of rotation 34 and is at an angle of between 80° and 60° with respect thereto, enabling comparatively efficient movement of the air along the axis of rotation 34 through the openings formed between the fan blades 30. Owing to the inclination of the fan blades 30, a preferential direction of rotation 43 is formed. When the impeller 28 rotates about the axis of rotation 34 in the preferential direction of rotation 43, air is sucked through the radiator 12 by means of the impeller 28. With a different direction of rotation, the air would move in the direction of travel 16 through the radiator 12. To improve efficiency, the fan blades 30 are furthermore of profiled configuration, and thus have an aerodynamic profile. Thus, an air throughput is increased. In summary, the impeller 28 has a preferential direction of rotation 43 about the axis of rotation 34.

Each fan blade 30 has a radially inner section 44, which is of substantially rectilinear radial or slightly C-shaped configuration in a plan view along the axis of rotation 34. The radially inner section 44 has the radially inner end 42 and merges into a section 46 of s-shaped configuration which has the radially outer end 40. Thus, the s-shaped sections 46 are offset outward in the respective radial direction with respect to the axis of rotation 34. On account of the s-shaped configuration of the section 46, the radial outer ends 40 of the fan blades 30 are offset counter to a preferential direction of rotation 48, the complete s-shaped section 46 being offset in each case in the preferential direction of rotation 43 with respect to the respective radially inner section 44.

In summary, the fan blades 30 are inclined with respect to the axis of rotation 34 and each have the section 46 which is s-shaped in a plan view along the axis of rotation 34. In this case, the extent of each fan blade 30 in the tangential direction, that is to say parallel to the preferential direction of rotation 43, does not change or changes only by less than 5% of the extent of the respective fan blade 30 in the tangential direction. In other words, each fan blade 30 has the same thickness in the tangential direction, that is to say along the preferential direction of rotation 43. Thus, comparatively efficient movement of the air is made possible.

As a result of the s-shaped section 46, the impeller 28 acts in the manner of a nozzle on the inflow side, that is to say on the side of the radiator 12, and acts in the manner of a diffuser on the outflow side, that is to say on the opposite side from the radiator 12. Thus, an additional radial motion component is introduced into the air flow generated or at least amplified by means of the impeller 28, and this component is thus directed away from the internal combustion engine 4. Thus, the air flow does not impinge at an obtuse angle on the internal combustion engine 4, which leads to reduced turbulence. Moreover, an area traversed by the air flow is increased on the downstream side, i.e. counter to the direction of travel 16, in comparison with the size of the aperture 20, and therefore a velocity of the air is reduced and consequently a pressure is increased. Consequently, an air volume throughput through the fan frame 14 and therefore also through the radiator 12 is increased at a constant rotational speed about the axis of rotation 34. Thus, efficiency is also increased. Alternatively, it is possible to rotate the impeller 28 at a lower rotational speed and thus to use a less powerful electric motor 18, which reduces production costs. Noise generation is also reduced. Moreover, separation of the air flow in the region of the outer ring 32 is reduced or avoided, which further increases efficiency.

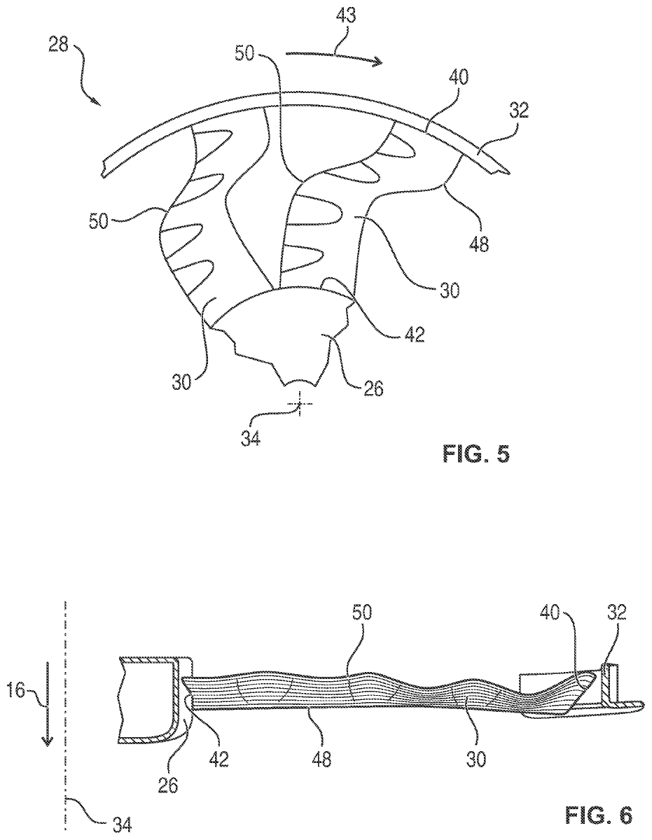

FIG. 5, corresponding to the illustration in FIG. 4, shows a modification of the impeller 28, wherein the outer ring 32 and the hub 26 as well as the number of impellers 30 is unchanged. Here too, as in the previous example, each fan blade 30 has a leading edge 48 in the preferential direction of rotation 43. The leading edge 48 is likewise s-shaped in the region of the s-shaped section 46. The leading edge 48 is rounded over its entire length perpendicularly to its course, but is otherwise straight. In other words, the leading edge 48 does not extend in the axial direction, that is to say parallel to the axis of rotation 34. In summary, the leading edge 48 of the fan blades 30 with respect to the preferential direction of rotation 43 is straight in a plan view counter to the preferential direction of rotation 43.

In comparison with the preceding embodiment, however, the trailing edge 50 is no longer of straight configuration in a plan view in the preferential direction 34. On the contrary, the trailing edge 50 of the fan blades 30 with respect to the preferential direction of rotation 43 is undulating in a plan view in the preferential direction of rotation 34, as shown in FIG. 6. The trailing edge 50 thus has a wave shape, such as a sinusoidal course. In this case, both the radially inner section 44 and the s-shaped section 46 are undulating in the region of the trailing edge 50. The region between the two edges 48, 50 extends in a substantially continuous manner, but at least steadily, between the two edges 48, 50. As in the preceding example, the trailing edge 50 is offset with respect to the leading edge 48 owing to the inclination counter to the direction of travel 16, resulting in the preferential direction of rotation 43.

In summary, each of the fan blades 30, that is to say each blade airfoil, has the s-shaped section 46, which may be of boomerang-shaped configuration in the manner of a blade securing means. By means of this configuration, separation of the air flow from the outer ring 32 is prevented or at least reduced, such as if the radiator 12 is present. In addition, a radially outward motion component is introduced into the air flow passing through the impeller 28, such as if the radiator 12 is not present. The air is thus directed radially outward in the outflow direction. As a result of such a configuration, efficiency is increased and noise generation is positively influenced.

The invention is not restricted to the exemplary embodiments described above. On the contrary, other variants of the invention can also be derived therefrom by a person skilled in the art without departing from the subject matter of the invention. In particular, all the individual features described in connection with the individual exemplary embodiments can also be combined with one another in some other way without departing from the subject matter of the invention.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE SIGNS

2 motor vehicle
4 internal combustion engine
6 wheel
8 radiator fan
10 line
12 radiator
14 fan frame
16 direction of travel
18 electric motor
20 aperture
22 rim
24 motor mount
26 hub
28 impeller
30 fan blades
32 outer ring
34 axis of rotation
36 dynamic pressure flap
38 flap
40 radially outer end
42 radially inner end
43 preferential direction of rotation
44 radially inner section
46 s-shaped section
48 leading edge
50 trailing edge

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An impeller for use in a motor vehicle, the impeller comprising:
a hub; and
a number of fan blades attached to the hub and inclined with respect to an axis of rotation of the impeller, the number of fan blades each including a section having an shape with respect to a plan view along the axis of rotation.

2. The impeller of claim 1,
wherein the impeller is configured to rotate about the axis of rotation in
a preferential direction of rotation.

3. The impeller of claim 2,
wherein radial outer ends of each of the number of fan blades are offset counter to the preferential direction of rotation.

4. The impeller of claim 2,
wherein a trailing edge of each of the number of fan blades, with respect to the preferential direction of rotation, is undulated with respect to the preferential direction of rotation.

5. The impeller of claim 2, wherein
a leading edge of each of the number of fan blades, with respect to the preferential direction of rotation, is straight with respect to a plan view counter to the preferential direction of rotation.

6. The impeller of claim 1,
wherein each of the sections are outwardly offset from one another in a radial direction with respect to the axis of rotation.

7. The impeller of claim 1,
wherein each of the number of fan blades are arranged in a rotationally symmetrical manner with respect to the hub.

8. The impeller of claim 1, wherein the number of fan blades includes a first fan blade and a second fan blade and a differential between an extent of the first fan blade and an extent of the second fan blade is less than 10%, wherein the extent of the first fan blade and the extent of the second fan blade are formed with respect to a tangential direction of the first and second fan blades.

9. The impeller as claimed in claim 1, further comprising:
an outer ring arranged concentrically with the hub, wherein each of the fan blades of the number of fan blades include a radial outer end attached to the outer ring.

10. A radiator fan or use in a motor vehicle, the radiator fan comprising:
a fan frame forming a round aperture;
an electric motor; and
an impeller including,
a hub, and
a number of fan blades attached to the hub and inclined with respect to an axis of rotation of the impeller, the number of fan blades each including a section having an s-shape with respect to a plan view along the axis of rotation.

11. The impeller of claim 8, wherein the differential between the extent of the first blade and the extent of the second blade is less than 5%.

12. The radiator of claim 10, wherein the impeller is configured to rotate about the axis of rotation in a direction of rotation and radial outer ends of each of the number of fan blades are offset counter to the preferential direction of rotation.

13. The radiator of claim 10, wherein a trailing edge of each of the number of fan blades, with respect to a direction of rotation, is undulated with respect to the preferential direction of rotation.

14. The radiator of claim 10, wherein a leading edge of each of the number of fan blades, with respect to a direction of rotation, is straight with respect to a plan view counter to the preferential direction of rotation.

15. The radiator of claim 10, wherein each of the sections are outwardly offset from one another in a radial direction with respect to the axis of rotation.

16. An impeller for use in a motor vehicle, the impeller comprising:
a hub configured to rotate about a rotational axis in a first rotational direction; and
a number of fan blades extending from the hub, each of the fan blades including,
an inner end fixed to the hub,
an outer end disposed radially outwardly from the inner end, and
an S-shaped section extending between the inner end and the outer end, wherein the outer end leads the inner end with respect to the first rotational direction.

17. The impeller of claim 16, wherein a leading edge, with respect to the first rotational direction, of each of the number of fan blades extends perpendicularly to the rotational axis.

18. The impeller of claim 16, wherein each of the number of fan blades are arranged in a rotationally symmetrical manner with respect to the hub.

19. The impeller of claim 16, a trailing edge, with respect to the first rotational direction, of each of the number of fan blades has a sinusoidal wave shape.

20. The impeller of claim 16, further comprising:
an outer ring arranged concentrically with the hub, wherein each outer end of the number of fan blades is attached to the outer ring.
